(19) United States
(12) Patent Application Publication
(10) Pub. No.: US 2013/0219833 A1
(43) Pub. Date: Aug. 29, 2013

(54) HEAT SEALABLE COATED NYLON

(71) Applicant: Honeywell International Inc., (US)

(72) Inventors: Yuan-Ping R. Ting, Plainsboro, NJ (US); Simon J. Porter, Allentown, PA (US); Ken Guhse, Monroe, NC (US); Awdhoot V. Kerkar, Rockaway, NJ (US); Gary Martin, Piscataway, NJ (US)

(73) Assignee: HONEYWELL INTERNATIONAL INC., Morristown, NJ (US)

(21) Appl. No.: 13/777,875

(22) Filed: Feb. 26, 2013

Related U.S. Application Data
(60) Provisional application No. 61/603,664, filed on Feb. 27, 2012.

(51) Int. Cl. B65D 65/42; C09D 133/02; C09D 175/04

(52) U.S. Cl. CPC B65D 65/42; C09D 175/04; C09D 133/02
USPC 53/463; 428/349; 428/341; 428/220; 428/35.2; 524/507

(57) ABSTRACT

A heat sealable coated nylon film comprising a layer having a first and a second surface, the layer consisting essentially of nylon, and a coating on the first surface of said layer, wherein the coating is water-based and adapted for making the coated nylon film heat sealable and wherein the coating comprises a polyurethane and a polymer selected from the group consisting of polyolefin, EVA, EAA, ethylene methacrylic copolymer, and a combination thereof. A processes of forming said coated nylon film, a packaged product comprising a product and said heat sealable coated nylon film in which the product is wrapped, and a process of packaging said product.

### CROSS REFERENCE TO RELATED APPLICATIONS

The present application claims priority under 35 U.S.C. §119(e) to U.S. Provisional Patent Application No. 61/603,664, filed on Feb. 27, 2012, the disclosure of which is incorporated herein by reference in its entirety.

### FIELD OF THE INVENTION

The invention relates to sealable coated nylon films and methods of making such coated nylon films. The invention also relates to products packaged with a sealable coated nylon film and methods of using such film to make such packaged products.

### BACKGROUND OF THE INVENTION

The local environment surrounding food and certain other products, including the amount of moisture, influences to what extent such products can be preserved. Both single layer and multilayer (laminated) films, either coated or uncoated, have been used to control this local environment. The laminates and films used may have a heat sealable inside surface so that they can completely enclose a product and thereby protect it more effectively. The laminates and films used are also relatively impervious to oxygen and have an outside surface of sufficient durability. Finally, laminates and films must not adversely affect the product.

The laminates and films used for packaging food and other products are typically made from plastics. Plastics are a special group of polymers that can easily be shaped into a desired form by heat and pressure. Upon cooling, the plastic becomes hard and retains the new shape. Thermoplastics can be heat-shaped repeatedly, whereas so-called thermoset materials can be shaped only once. The vast majority of plastic used in packaging are thermoplastics. See, e.g., Susan E. M. Selke, Plastic Packaging, Carl Hanser Verlag, 2^{nd} Edition, 2004, pages 9-10.

Heat sealing is the process by which two structures each containing at least one thermoplastic layer are sealed by the combined action of heat and pressure. When sealing a laminate or film to make a package, the sealing layers are located at the interface, contacting another sealing layer. The heat at the interface must be sufficient to melt the interface materials to produce a seal. A good seal is obtained when enough molecular entanglement has taken place within the polymer chains from the two thermoplastic heat sealing layers to destroy the interface and produce a homogenous layer that remains homogenous after cooling. See, e.g., Susan E. M. Selke, Plastic Packaging, Carl Hanser Verlag, 2^{nd} Edition, 2004, pages 180-181.

Plastics commonly used for food packaging are, for example, polyethylene (“PE”), polypropylene (“PP”), ethyl vinyl acetate (“EVA”), ethylene acrylic acid (“EAA”), polyvinyl chloride (“PVC”), polyvinylidene chloride (“PVdC”), polystyrene (“PS”), ethylene methacrylic acid copolymer and nylon. Ethylene methacrylic acid copolymer is commercially available, for example, under the tradename Surlyn® from DuPont.

Nylon is the generic name for a family of polyamide polymers characterized by the presence of the amide group —CONH in the backbone. Advantages of nylon films relative to other film materials in packaging applications include, flex crack resistance, puncture resistance, good flavor and aroma barrier characteristics, good moisture permeability, durability at low temperatures, and thermal stability. Nylon is, however, not heat sealable, which means that an unmodified nylon film cannot be used to seal and insulate food or other products from the surrounding environment. To make nylon heat sealable, it has to be coated with, or laminated to, a material that is heat sealable.

Coating nylon with a thin layer of heat sealable material to produce a heat sealable nylon based film is generally not possible because such coatings do not sufficiently adhere to nylon. Laminating nylon with a heat sealable plastic material is impractical because the thickness of plastic films reduces their permeability to moisture and thus the desired level of moisture flux through the laminate.

### SUMMARY OF THE INVENTION

The invention provides a heat sealable coated nylon film comprising a layer having a first and a second surface, wherein the layer consists essentially of nylon. The first surface of the layer is coated with a coating that is water-based and adapted for making the coated nylon film heat sealable, wherein the coating comprises a polyurethane and a polymer selected from the group consisting of polyolefin, EVA, EAA, ethylene methacrylic acid copolymer, and a combination thereof.

The invention also provides a process of forming said heat sealable coated nylon film comprising a step of forming a coating by mixing a polyurethane and a polymer selected from the group consisting of polyolefin, EVA, EAA, ethylene methacrylic acid copolymer, and a combination thereof, and applying the coating to the first surface of a layer having a first and a second surface and consisting essentially of nylon. The coating is water-based and adapted for making the coated nylon film heat sealable.

The invention also provides a packaged product comprising a product and said heat sealable coated nylon film in which the product is wrapped.

The invention also provides a process of packaging a product comprising a step of wrapping the product in said heat sealable coated nylon film and sealing the heat sealable coated nylon film.

In some embodiments of the present invention, the polyurethane and the polymer are present in the coating at a dry weight ratio of between 90:10 and 10:90.

In other embodiments of the present invention, the coating has a dry weight of between 0.09 g/m² and 1.6 g/m².

In other embodiments of the invention, the layer consists essentially of biaxially oriented nylon 6.

In other embodiments of the present invention, the heat sealable coated nylon film has a moisture vapor transmission rate of between about 2 grams per 100 square inches (0.0645 m²) per day and about 36 grams per 100 square inches (0.0645 m²) per day. More preferably, the heat sealable coated nylon film has a moisture vapor transmission rate of between about 4 grams per 100 square inches (0.0645 m²) per day and about 12 grams per 100 square inches (0.0645 m²) per day.

In other embodiments of the present invention, the heat sealable coated nylon film has a thickness of between about 0.5 mil (13 μm) and about 1.5 mil (38 μm). More preferably, the heat sealable coated nylon film has a thickness of between about 1.0 mil (25 μm) and about 1.35 mil (34 μm). Most preferably, the heat sealable coated nylon film has a thickness of between about 1.007 mil (25.17 μm) and about 1.040 mil (26 μm).

In other embodiments of the present invention, the heat sealable coated nylon film has a heat seal strength of between 300 g/25 mm (0.67 lb/inch) and 900 g/25 mm (2 lb/inch).

### DETAILED DESCRIPTION OF THE INVENTION

It has been found that a coated nylon film can be manufactured, which is heat sealable and at the same time sufficiently moisture permeable for those applications which require moisture permeability. This heat sealable coated nylon film can be manufactured by coating nylon in a one step process.

The invention provides a heat sealable coated nylon film. Nylons are conventionally used in the art of multilayered packaging films. Suitable nylons within the scope of the invention are disclosed, for example, in U.S. Pat. No. 6,726,968, the disclosure of which is incorporated herein by reference. Such suitable nylons include homopolymers or copolymers selected from aliphatic polyamides and aliphatic/aromatic polyamides having a molecular weight of from about 10,000 to about 100,000. General procedures useful for the preparation of polyamides are well known to the art. Such include the reaction of diacids with diamines. Useful diacids for making polyamides include dicarboxylic acids which are represented by the general formula HOOC—Z—COOH wherein Z is representative of a divalent aliphatic radical containing at least 2 carbon atoms, such as adipic acid, sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid and terephthalic acid. Suitable diamines for making polyamides include those having the formula H₂N(CH₂)ₙNH₂ wherein n has an integer value of 1-16, and includes such compounds as trimethylenediamine, tetramethylenediamine, pentamethylenediamine, hexamethylenediamine, octamethylenediamine, decamethylenediamine, dodecamethylenediamine, hexadecamethylenediamine, aromatic diamines such as p-phenylenediamine, 4,4′-diaminodiphenyl ether, 4,4′-diaminodiphenyl sulfone, 4,4′-diaminodiphenylmethane, alkylated diamines such as 2,2-dimethylpentamethylenediamine, 2,2,4-trimethylhexamethylenediamine, and 2,4,4 trimethylpentamethylenediamine, as well as cycloaliphatic diamines, such as diaminodicyclohexylmethane, and other compounds. Other useful diamines include heptamethylenediamine, nonamethylenediamine, and the like. See U.S. Pat. No. 6,726,968.

Useful polyamide homopolymers include poly(4-aminobutyric acid) (nylon 4), poly(6-aminohexanoic acid) (nylon 6, also known as poly(caprolactam)), poly(7-aminoheptanoic acid) (nylon 7), poly(8-aminooctanoic acid) (nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12), nylon 4,6, poly(hexamethylene adipamide) (nylon 6,6), poly(hexamethylene sebacamide) (nylon 6,10), poly(heptamethylene pimelamide) (nylon 7,7), poly(octamethylene suberamide) (nylon 8,8), poly(hexamethylene azelamide) (nylon 6,9), poly(nonamethylene azelamide) (nylon 9,9), poly(decamethylene azelamide) (nylon 10,9), poly(tetramethylenediamine-co-oxalic acid) (nylon 4,2), the polyamide of n-dodecanedioic acid and hexamethylenediamine (nylon 6,12), the polyamide of dodecamethylenediamine and n-dodecanedioic acid (nylon 12,12) and the like. Useful aliphatic polyamide copolymers include caprolactam/hexamethylene adipamide copolymer (nylon 6,6/6), hexamethylene adipamide/caprolactam copolymer (nylon 6/6,6), trimethylene adipamide/hexamethylene azelaiamide copolymer (nylon trimethyl 6,2/6,2), hexamethylene adipamide-hexamethylene-azelaiamide caprolactam copolymer (nylon 6,6/6,9/6) and the like. Also included are other nylons which are not particularly delineated here. Of these polyamides, preferred polyamides include nylon 6, nylon 6,6, nylon 6/6,6 as well as mixtures of the same. See U.S. Pat. No. 6,726,968.

Aliphatic polyamides used in the practice of this invention may be obtained from commercial sources or prepared in accordance with known preparatory techniques. For example, poly(caprolactam) can be obtained from Honeywell International Inc., Morristown, N.J. under the trademark AEGIS®.

Exemplary of aliphatic/aromatic polyamides include poly(tetramethylenediamine-co-isophthalic acid) (nylon 4,1), polyhexamethylene isophthalamide (nylon 6,I), hexamethylene adipamide/hexamethylene-isophthalamide (nylon 6,6/6I), hexamethylene adipamide/hexamethylene-terephthalamide (nylon 6,6/6T), poly(2,2,2-trimethyl hexamethylene terephthalamide), poly(m-xylylene adipamide) (MXD6), poly(p-xylylene adipamide), poly(hexamethylene terephthalamide), poly(dodecamethylene terephthalamide), polyamide 6T/6I, polyamide 6/MXDT/I, polyamide MXDI, and the like. Blends of two or more aliphatic/aromatic polyamides can also be used. Aliphatic/aromatic polyamides can be prepared by known preparative techniques or can be obtained from commercial sources. Other suitable polyamides are described in U.S. Pat. Nos. 4,826,955 and 5,541,267, the disclosures of which are incorporated herein by reference.

In general, nylon films are made by processes well known in the art, such as cast or tubular extrusion.

Oriented nylon films are known in the packaging industry for their toughness, puncture resistance, and a moderate level of oxygen barrier. In particular, biaxial orientation is known to generally improve the strength of a nylon layer.

In some embodiments of the present invention, the layer consists essentially of biaxially oriented nylon 6. Biaxially oriented nylon may be manufactured by using any conventional method known in the art for orienting a film. The film may be stretched uniaxially in each of the longitudinal direction coincident with the direction of movement of the film being withdrawn from the film forming apparatus, also referred to in the art as the “machine direction,” and in a direction which is perpendicular to the machine direction, and referred to in the art as the “transverse direction” to thereby produce a biaxially oriented film. Biaxial orientation may be conducted by sequentially orienting the film in each of its longitudinal and transverse directions, in either order. After the orientation process, the film may be heat set to control shrinkage and crystallinity. Alternatively, biaxial orientation may be conducted by simultaneously orienting the film in each of its longitudinal and transverse directions by passing the film through a heated oven. Use of a large number of heating zones may facilitate orientation and controls shrinkage.

Biaxially oriented film may also be produced by the “double” bubble blown film process. In the “double” bubble process the polymer blend is extruded through a circular die and blown to a minimal blow up ratio and then quenched. This initial orientation process produces a film with insufficient physical properties, due to the poor orientation possible in the molten state. This initially produced film is most commonly oriented at less than two times in both the machine and transverse directions. After the initial quenching step, the film is subsequently reheated such that the collapsed bubble can be oriented approximately three times in both the machine and transverse directions. After orientation the film then passes through a series of heated zones to “set” the orientation and limit shrinkage. Films produced according to the present invention may be oriented by stretching or drawing the films at draw ratios of from about 1.1:1 to about 10:1 in each direction. In a preferred embodiment, the draw ratio is from about 2:1 to about 5:1 in each direction. The term “draw ratio” as used herein indicates the increase of dimension in the direction of the draw. Therefore, a film having a draw ratio of 2:1 has its length doubled during the drawing process. Generally, the film is drawn by passing it over a series of preheating and heating rolls or passing it through a series of preheating hot air ovens. The heated film may then move through a set of nip rolls downstream at a faster rate than the film entering the nip rolls at an upstream location to orient in a single direction or it may be simultaneously oriented by holding the film by the edges as it passes through an orienting oven. The change of rate is compensated for by stretching in the film.

Biaxially oriented nylon 6 used in the practice of this invention may be prepared in accordance with known preparatory techniques or obtained from commercial sources. For example, biaxially oriented nylon 6 films may be obtained from Honeywell International Inc., Morristown, N.J., under the trademark CAPRAN®.

The invention provides a coating that is water-based and adapted for making the coated nylon film heat sealable, wherein the coating comprises a polyurethane and a polymer selected from the group consisting of polyolefin, EVA, EAA, ethylene methacrylic acid copolymer and a combination thereof.

Polyurethanes are generally the product of the reaction of a polyol component with an isocyanate component. Polyols are typically polyethers containing terminal hydroxyl groups, while isocyanates are typically aromatic or aliphatic polyisocyanates. The urethane polymer of this invention may be composed of a polyol or mixture of polyols containing acidic functionality which will allow crosslinking, and an aliphatic diisocyanate. Examples of polyols which might be used to prepare the urethane polymer of this invention would include polyether polyols grafted with, for example, maleic or fumaric acid, as taught in U.S. Pat. Nos. 4,460,738 and 4,528,334, or mixtures of a polyol free of acid functionality with an acid-functional compound which also has hydroxyl, amine or thiol functionality. Examples of isocyanates which might be used to prepare the urethane polymer of this invention might include m-tetramethylxylene diisocyanate or p-tetramethylxylene diisocyanate. Urethane polymers of the type useful in the current invention are described in U.S. Pat. No. 5,494,960 which is incorporated herein by reference.

Polyolefins are polymers derived from alkene monomers of the general formula CₙH₂ₙ, where one or more of the alkene monomer hydrogens may be substituted by an alkyl group. Nonlimiting examples of polyolefins include polyethylene and polypropylene. Other examples of polyolefins may be found in Susan E. M. Selke, Plastic Packaging, Carl Hanser Verlag, 2^{nd} Edition, 2004. Examples of polyolefins can also be found in U.S. Pat. No. 5,766,772.

Ethylene methacrylic acid copolymer is another polymer/copolymer the use of which is within the scope of the present invention. It is commercially available, for example, under the tradename Surlyn® from DuPont.

The use of ethylene acrylic acid (EAA) and ethylene vinyl acetate (EVA) is also within the scope of the present invention. EAA and EVA are widely known and used in the art and commercially available from many sources known to the person having ordinary skill in the art.

All of the polymers/copolymers disclosed herein and their use for coating plastic films, including nylon, are well known in the art. See, for example, Susan E. M. Selke, Plastic Packaging, Carl Hanser Verlag, 2^{nd} Edition, 2004.

In one embodiment of the invention, the polyurethane and the polymer are present in the coating composition at a dry weight ratio of between 90:10 and 10:90. In other embodiments of the present invention, the polyurethane and the polymer are present in the coating composition at a dry weight ratio of between 90:10 and 80:20, of between 80:20 and 60:40, of between 60:40 and 40:60, of between 40:60 and 20:80, and of between 20:80 and 10:90.

The coating composition may contain additional ingredients such as fillers and surfactants. Non exclusive examples of suitable fillers include a wide variety of minerals, metals, metal oxides, siliceous materials, metal salts, and mixtures thereof. These fillers may optionally be treated with various coupling agents or adhesion promoters, as is known to those skilled in the art. Examples of fillers included in these categories are silica, titanium dioxide, alumina, aluminum hydrates, feldspar, asbestos, talc, calcium carbonates, clay, carbon black, quartz, novaculite and other forms of silica such as kaolinite, bentonite, garnet, mica, saponite, beidelite, calcium oxide, calcium hydroxide, etc. The weight percentage of the filler in the coating composition ranges from at about 0.01% to about 0.12%, preferably from about 0.02% to about 0.08% based on the weight of the coating composition. In a preferred embodiment of the invention, the filler is silica. In one preferred embodiment of the invention, the particle size of the filler ranges from about 12 nm to about 5 μm. In another preferred embodiment of the invention, the particle size of the filler ranges from about 12 nm to about 400 nm. When optical transparency is important, these ranges should not be exceeded.

Suitable surfactants include anionic, cationic, nonionic, amphoteric and zwitterionic surfactants which are compatible with the other composition ingredients. Nonexclusive examples of such surfactants include anionic surfactants, for example, sulfated or sulfonated synthetic organic detergents. The useful sulf(on)ated detergents include the linear higher alkylbenzene sulfonates, olefin sulfonates and paraffin sulfonates, and higher fatty alcohol sulfates, higher fatty alcohol polyethoxylate sulfates (of 3 to 30 ethoxy groups, preferably 3 to 15), monoglyceride sulfates, and other commercially available sulf(on)ates of satisfactory surface activity and compatibility. Such products may contain a lipophilic moiety which includes a higher aliphatic group. In a preferred embodiment of the invention, this group is a higher linear alkyl. Such alkyl will normally be of 8 to 20 carbon atoms, preferably being of 10 to 18 carbon atoms, e.g., lauryl, myristyl, and cetyl.

Nonionic synthetic organic detergents optionally employed in the practice of the invention may be any of a wide variety of such compounds which are well known in the art. Suitable nonionic surfactants are poly-lower alkoxylated lipophiles wherein the desired hydrophile-lipophile balance is obtained from addition of a hydrophilic poly-lower alkoxy group to a lipophilic moiety. In a preferred embodiment of the invention, the nonionic detergent employed is the poly-lower alkoxylated higher alkanol wherein the alkanol is of 10 to 18 carbon atoms and wherein the number of mols of lower alkylene oxide (of 2 or 3 carbon atoms) is from 3 to 12.

Other anionic, cationic, nonionic, amphoteric and zwitterionic surfactants are described at length in the text Surface Active Agents, Vol. II, by Schwartz, Perry and Berch, published in 1958 by Interscience Publishers and in McCutcheon's Detergents and Emulsifiers, 1969 Annual. In one preferred embodiment of the invention, the weight percentage of the surfactant in the coating composition ranges from at about 0.05% to about 2%, based on the weight of the coating composition. In another preferred embodiment of the invention, the weight percentage of the surfactant in the coating composition ranges from about 0.1% to about 1%, based on the weight of the coating composition.

The invention provides a process of forming a heat sealable coated nylon film comprising a step of forming a coating by mixing a polyurethane and a polymer and applying the coating to the first surface of a layer having a first and a second surface and consisting essentially of nylon. The coating composition of the present invention can be made in any conventional manner such as by mixing the polyurethane with sufficient water to form a dispersion, adding a crosslinker and the polymer and optionally adding a filler and surfactant to a vessel with vigorous spring, for example for from about 15 to about 20 minutes.

The crosslinker of the current invention has the characteristics that it can be combined with an aqueous dispersion of the urethane polymer, that it will react with the polymer on drying, and that the resulting crosslinked film will be durable and optically clear. Such a crosslinker may be a chemical compound bearing at least three functional groups, in a preferred embodiment the same group, which will react with the acid functionality on the urethane polymer to generate a covalent bond. Examples of functional groups which will react with a carboxylic acid in this way include amines, hydroxyl groups, and thiol groups. The crosslinker should either be soluble in water, or easily dispersed in water. Preferred crosslinkers include melamine formaldehydes, isocyanates and aziridines. Suitable crosslinkers include trimethylolpropane tris[3-(2-methylaziridinyl)propanoate. Another effective crosslinker is the polymer generated by reaction of 1,3,5-triazine-2,4,6-triamine with formaldehyde. A preferred crosslinker is a compound containing at least two aziridine groups. The weight percentage of the crosslinker in the coating composition ranges from about 1% to about 10% based on the weight of the coating composition including water. In some preferred embodiments of the invention, the weight percentage of the crosslinker in the coating composition ranges from about 1.0% to about 3.0%. In other preferred embodiments of the invention, the weight percentage of the crosslinker in the coating composition ranges from about 1.5% to about 2.0%.

The aqueous dispersion of polyurethane, crosslinker, polymer, and optionally other components may be applied to the nylon film by any of several methods known to those skilled in the art. It is essential that this coating be smooth such that after curing no gaps, scratches or other optical defects are present. For example, the coating composition may be applied to the polyamide film by knife coating, coating with a Meyer rod, gravure coating, forward and reverse roll coating, die coating, spraying, doctoring, brushing, dipping, meniscus coating or air knife techniques which are well known in the art. It will be understood by those skilled in the art that the optimum concentration of polymeric components in the aqueous dispersion will vary depending on the coating method used.

After the coating composition has been applied to the polyamide film, the coating should be dried to remove the water, and allow the crosslinking reaction to occur. Typically, in a commercial operation, the coating operation will operate continuously on a sheet of film passing through the coater, and this coated film will then pass into an oven. Any type of oven, convection or infrared, for example, could be used to dry the coating. The oven temperature required to dry the coating will depend on the amount of liquid to be removed, as well as the size of the oven, air flow rate (cubic meter per minute) and the line speed with which the film passes through the oven; shorter times require higher temperatures. In a preferred embodiment, the temperature ranges from about 65° C. to about 205° C. In another preferred embodiment, the temperature ranges from about 90° C. to about 125° C. The dwell time at such temperature preferably ranges from about 1 second to about 10 seconds, more preferably from about 3 seconds to about 7 seconds.

Any crosslinking method known to those skilled in the art may be used, however, heating is preferred in order to effect a crosslinking of the polyurethane by the crosslinker. Heating may be done in conventional ovens, circulating ovens, or be done by infrared radiation or by heat lamps. The coating composition should be applied to the polyamide film before the optional stretching. After the application of the coating, the coated nylon film may be oriented uniaxially or biaxially.

In some embodiments of the present invention, the coating has a dry weight of between 0.09 g/m² and 1.6 g/m². In other embodiments of the invention, the coating has a dry weight of between 0.09 g/m² and 0.36 g/m², between 0.36 g/m² and 0.72 g/m², between 0.72 g/m² and 1 g/m², and between 1 g/m² and 1.43 g/m². In other embodiments of the invention, the coating has a dry weight of between 0.16 g/m² and 0.98 g/m². While such coating weights are preferred, it is to be understood that other film coating weights may be produced to satisfy a particular need and yet fall within the scope of the present invention.

The nylon layer and the coating may optionally also include one or more conventional additives whose uses are well known to those skilled in the art. The use of such additives may be desirable in enhancing the processing of the compositions as well as improving the products or articles formed therefrom. Examples of such additives include: oxidative and thermal stabilizers, lubricants, release agents, flame-retarding agents, oxidation inhibitors, oxidation scavengers, dyes, pigments and other coloring agents, ultraviolet light absorbers and stabilizers, organic or inorganic fillers including particulate and fibrous fillers, reinforcing agents, nucleators, plasticizers, as well as other conventional additives known to the art. Such additives may be used in amounts, for example, of up to about 10% by weight of the overall composition. Representative ultraviolet light stabilizers include various substituted resorcinols, salicylates, benzotriazole, benzophenones, and the like. Suitable lubricants and release agents include stearic acid, stearyl alcohol, and stearamides. Exemplary flame-retardants include organic halogenated compounds, including decabromodiphenyl ether and the like as well as inorganic compounds. Suitable coloring agents including dyes and pigments include cadmium sulfide, cadmium selenide, titanium dioxide, phthalocyanines, ultramarine blue, nigrosine, carbon black and the like. Representative oxidative and thermal stabilizers include the Period Table of Element's Group I metal halides, such as sodium halides, potassium halides, lithium halides as well as cuprous halides and chlorides, bromides, iodides. Also, hindered phenols, hydroquinones, aromatic amines as well as substituted members of those above mentioned groups and combinations thereof. Exemplary plasticizers include lactams such as caprolactam and lauryl lactam, sulfonamides such as o,p-toluenesulfonamide and N-ethyl, N-butyl benzylnesulfonamide, and combinations of any of the above, as well as other plasticizers known to the art.

In some embodiments of the invention, the heat sealable coated nylon film has a moisture vapor transmission rate of between about 2 grams per 100 square inches (0.0645 m²) per day and about 36 grams per 100 square inches (0.0645 m²) per day. More preferably, the heat sealable coated nylon film has a moisture vapor transmission rate of between 4 grams per 100 square inches (0.0645 m²) per day and 12 grams per 100 square inches (0.0645 m²) per day. Moisture vapor transmission rates (MVTR) are measured using the ASTM F1249-Method, as described in the Examples below. Per the ASTM F1249-Method, the MVTR of a film consisting essentially of nylon 6 and having a thickness of about 1.0 mil (25 μm) is about 11-13 grams per 100 square inches (0.0645 m²) per day at 100% RH (relative humidity), 100° F. (37.77° C.). Per the ASTM F1249-Method, the MVTR of a film consisting essentially of nylon 6 and having a thickness of about 0.5 mil (13 μm) is about 24 grams per 100 square inches (0.0645 m²) per day at 100% RH (relative humidity), 100° F. (37.77° C.). Per the ASTM F1249-Method, the MVTR of a film consisting essentially of nylon 6 and having a thickness of about 0.33 mil (8.4 μm) is about 36 grams per 100 square inches (0.0645 m²) per day at 100% RH (relative humidity), 100° F. (37.77° C.). Films consisting essentially of nylon 6 and having a thickness of 0.4 mil (10 μm) and above may be used to practice the instant invention.

In some embodiments of the invention, the heat sealable coated nylon film has a thickness of between 0.5 mil (13 μm) and 1.5 mil (38 μm). More preferably, the heat sealable coated nylon film has a thickness of between about 1.0 mil (25 μm) and about 1.35 mil (34 μm). Most preferably, the heat sealable coated nylon film has a thickness of between about 1.007 mil (25.17 μm) and about 1.040 mil (26 μm). The thickness measurements are performed on a Mitutoyo Micrometer which has a reading accuracy of about 0.00001 inch (0.254 μm). Films consisting essentially of nylon 6 can be made, for example, as thin as 0.4 mil (10 μm).

In some embodiments of the present invention, the coating of the heat sealable coated nylon film has a thickness of between 0.09 μm and 1.64 μm. In other embodiments of the present invention, the coating of the heat sealable coated nylon film has a thickness of between 0.17 μm and 1 μm.

In some embodiments of the invention, the heat sealable coated nylon film has a heat seal strength of between 300 g/25 mm (0.67 lb/inch) and 900 g/25 mm (2 lb/inch). In other embodiments of the invention, the heat sealable coated nylon film has a heat seal strength of between 300 g/25 mm and 400 g/25 mm, between 400 g/25 mm and 500 g/25 mm, between 500 g/25 mm and 600 g/25 mm, between 600 g/25 mm and 700 g/25 mm and between 700 g/25 mm and 900 g/25 mm. The adhesion (i.e., heat seal strength) of the coated nylon films is measured as described in the Examples below.

Also within the scope of the present invention is a heat sealable coated film wherein this heat sealable coated film was made by coating one side of a film made from nylon 6 with the coating of the present invention and then biaxially orienting this coated film.

The invention provides a packaged product comprising a product and the heat sealable coated nylon film of the present invention in which the product is wrapped. The invention further provides a process of packaging a product comprising steps of wrapping the product in the heat sealable coated nylon film of the present invention. The use of plastic films to package products, including the process of sealing appropriate plastic films, is well documented in the art and therefore not further described herein.

### EXAMPLES

The following Examples are set forth to illustrate embodiments of the present invention and are not meant to be limiting in any way.

### Example 1

### Measurements of the Adhesion of Coated Nylon Films

The coating composition of the present invention was applied to the nylon films as described above. The coating of the present invention was then dried and the crosslinking reaction was allowed to occur. To determine the adhesion (i.e., heat seal strength) of the coated nylon films, a heat seal strength test was performed as follows. As a comparison, other coating compositions were applied to nylon, too, and characterized as set forth below. After the coated films were dried, the coated films were folded in half in such a way that the coatings of each half faced each other. The folded films were then put under a Sentinel heat sealer and sealed for about 2 seconds dwell time at about 375° F. (190.55° C.) and about 60 psi (413685.42 Pa) to create one inch (25.4 mm) long heat seal marks on the coated nylon films. The heat sealed nylon films were then cut into one inch long strips and the adhesion of the coating was tested using a T-Peel testing system from Instron® as the standard peel tester. The coating adhesion (heat seal strength) was recorded in pounds per inch (450 g/25 mm). Our measurements (see Table 1 below) showed that the heat sealable coated nylon film coated with a coating comprising polyurethane and EAA (coating no. 4) provided for a significantly stronger adhesion than nylon that was coated with EVA or polyurethane alone (coating nos. 1, 3 and 5). Coating no. 2 also provided for a strong adhesion, but required two coating steps, as opposed to one in the case of coating no. 4. Our measurements also showed that coatings requiring only one coating step have a lower coating weight. Coating weights were determined by Method ASTM D889-00 in g/m² (lb/3000 ft²).

TABLE 1

| | coating no. 1 | coating no. 2 | coating no. 3 | coating no. 4 | coating no. 5 |
|---|---|---|---|---|---|
| Company | Michelman | Michelman | Honeywell | Honeywell | Michelman |
| Chemistry | EAA | EAA | polyurethane | mixture of EAA | EAA |
| | dispersion | dispersion | | and polyurethane | dispersion |
| Substrate | 1 mil (25 μm) | 1 mil (25 μm) | 10 mil (254 μm) | 10 mil (254 μm) | 10 mil (254 μm) |
| | biaxial oriented | biaxial oriented | cast nylon before | cast nylon before | cast nylon before |
| | nylon | nylon with | biaxial orientation | biaxial orientation | biaxial orientation |
| | | polyurethane primer | | | |
| Total coating | 2 | 2 | 1 | 1 | 1 |
| steps on Nylon | | | | | |
| Final coating weight | 1.0-3.0/ | 1.0-3.0/ | 0.1-0.5/ | 0.1-0.5/ | 0.1-0.5/ |
| lb/3000 ft²/(g/m²) | (1.6-4.86) | (1.6-4.86) | (0.16-0.82) | (0.16-0.82) | (0.16-0.82) |
| Coating to coating | <0.5/ | >1.5/ | 0.1-0.3/ | 0.95-1.7/ | <0.5/ |
| heat seal strength | (<226) | (>680) | (45-136) | (430-771) | (<223) |
| at 375° F. (191° C.), | | | | | |
| 2 seconds, 60 psi, | | | | | |
| (lb/in)/(g/25 mm) | | | | | |
| Failure mode | coating comes | film break | coating separate | film break | coating comes |
| | off nylon film | | from coating | | off nylon film |
| Conclusion | poor heat | good heat | poor heat | good heat | poor heat |
| | sealable nylon | sealable nylon | sealable nylon | sealable nylon | sealable nylon |
| | | on two coats | | on one coat | |

### Example 2

### Water Permeability of Coated Nylon Films

The moisture vapor transmission rates (MVTR) of the coated nylon films was measured using the ASTM F1249-Method. Specifically, the heat sealable coated nylon films were cut to a specific shape based on the template. The film samples were then mounted to a Mocon Permatran W 3/31 machine (MVTR machine) in such a way that the side of the film that was coated was facing the moisture source during testing. The testing conditions were: 100% RH (relative humidity), 100° F. (37.77° C.). Moisture vapor transmission rates were calculated in gram per 100 square inches (0.0645 m²) per day. The MVTR of all in-line coated nylon films with various coatings was measured. The results of these measurements are depicted in the Table 2 below. Our measurements showed that coating B, comprising polyurethane and EAA, had a higher MVTR than three of the controls which comprised PVdC instead (coatings C, D and E). Coating A had a MVTR that was similar to the MVTR of coating B. However, coating A had poor adhesion properties (heat seal strength). The term “peelable” as used herein means that the heat seal strength test resulted in the coating peeling off the nylon to which it was attached. The term “destructive” as used herein means that the heat seal strength test resulted in the destruction of the coated nylon, but that the coating did not peel off the nylon.

TABLE 2

| | coating A | coating B | coating C | coating D | coating E |
|---|---|---|---|---|---|
| Chemistry | poly- | poly- | PVdC | PVdC | PVdC + |
| | urethane | urethane + | | | clay |
| | | EAA | | | |
| Coating to | peelable | destructive | destructive | peelable | destructive |
| coating | | | | | |
| heat seal | | | | | |
| strength | | | | | |
| MVTR at | 20.49 | 19.74 | 0.8 | 2.3 | 1.57 |
| 100° F. | | | | | |
| (38° C.)/ | | | | | |
| 100% RH | | | | | |
| (gm/100 in² | | | | | |
| (0.0645 m²)/ | | | | | |
| day) | | | | | |

What is claimed is:

1. A heat sealable coated nylon film comprising: a layer having a first and a second surface, the layer consisting essentially of nylon; and a coating on the first surface of said layer, wherein the coating is water-based and adapted for making the coated nylon film heat sealable and wherein the coating comprises a polyurethane and a polymer selected from the group consisting of polyolefin, EVA, EAA, ethylene methacrylic acid copolymer, and a combination thereof.

2. The heat sealable coated nylon film of claim 1, wherein the polyurethane and the polymer are present in the coating at a dry weight ratio of between 90:10 and 10:90.

3. The heat sealable coated nylon film of claim 2, wherein the coating has a dry weight of between 0.09 g/m² and 1.6 g/m².

4. The heat sealable coated nylon film of claim 3, wherein the layer consists essentially of biaxially oriented nylon 6.

5. The heat sealable coated nylon film of claim 4 having a moisture vapor transmission rate of between 2 grams per 0.0645 m² per day and 36 grams per 0.0645 m² per day, a thickness of between 13 μm and 38 μm, and a heat seal strength of between 300 g/25 mm and 900 g/25 mm.

6. A process of forming a heat sealable coated nylon film comprising a step of: forming a coating by mixing a polyurethane and a polymer selected from the group consisting of polyolefin, EVA, EAA, ethylene methacrylic acid copolymer, and a combination thereof, and applying the coating to the first surface of a layer having a first and second surface and consisting essentially of nylon; wherein the coating is water-based and adapted for making the coated nylon film heat sealable.

7. The process of claim 6, wherein the polyurethane and the polymer are present in the coating at a dry weight ratio of between 90:10 and 10:90.

8. The process of claim 7, wherein the coating has a dry weight of between 0.09 g/m² and 1.6 g/m².

9. The process of claim 8, wherein the layer consists essentially of biaxially oriented nylon 6.

10. The process of claim 9, wherein the heat sealable coated nylon film has a moisture vapor transmission rate of between 2 grams per 0.0645 m² per day and 36 grams per 0.0645 m² per day, a thickness of between 13 μm and 38 μm, and a heat seal strength of between 300 g/25 mm and 900 g/25 mm.

11. A packaged product comprising: a product and a heat sealable coated nylon film in which the product is wrapped, the heat sealable coated nylon film comprising: a layer having a first and a second surface, the layer consisting essentially of nylon; and a coating on the first surface of said layer, wherein the coating is water-based and adapted for making the coated nylon film heat sealable and wherein the coating comprises a polyurethane and a polymer selected from the group consisting of polyolefin, EVA, EAA, ethylene methacrylic acid copolymer, and a combination thereof.

12. The packaged product of claim 11, wherein the polyurethane and the polymer are present in the coating at a dry weight ratio of between 90:10 and 10:90.

13. The package product of claim 12, wherein the coating has a dry weight of between 0.09 g/m² and 1.6 g/m².

14. The packaged product of claim 13, wherein the layer consists essentially of biaxially oriented nylon 6.

15. The packaged product of claim 14, wherein the heat sealable coated nylon film has a moisture vapor transmission rate of between 2 grams per 0.0645 m² per day and 36 grams per 0.0645 m² per day, a thickness of between 13 μm and 38 μm, and a heat seal strength of between 300 g/25 mm and 900 g/25 mm.

16. A process of packaging a product comprising a step of wrapping the product in a heat sealable coated nylon film, the heat sealable coated nylon film comprising: a layer having a first and a second surface, the layer consisting essentially of nylon; and a coating on the first surface of said layer, wherein the coating is water-based and adapted for making the coated nylon film heat sealable and wherein the coating comprises a polyurethane and a polymer selected from the group consisting of polyolefin, EVA, EAA, ethylene methacrylic acid copolymer, and a combination thereof.
